(19) United States
(12) Patent Application Publication
(10) Pub. No.: US 2014/0006630 A1
(43) Pub. Date: Jan. 2, 2014

(54) SESSION INITIATION PROTOCOL (SIP) FOR MESSAGE THROTTLING

(71) Applicants: Yigang Cai, Naperville, IL (US); Suzann Hua, Lisle, IL (US)

(72) Inventors: Yigang Cai, Naperville, IL (US); Suzann Hua, Lisle, IL (US)

(21) Appl. No.: 13/536,713

(22) Filed: Jun. 28, 2012

(51) Int. Cl. G06F 15/16

(52) U.S. Cl. 709/227

(57) ABSTRACT

Systems and methods that use SIP for message throttling. A system includes a SIP client that communicates with a SIP server. When in operation, the SIP client sends a SIP request to the SIP server, such as a SIP INVITE. The SIP client then receives a SIP response from the SIP server answering the request. The SIP client parses the SIP response to identify an overload indicator which indicates that an overload condition exists in the SIP server, and limits additional SIP requests toward the SIP server based on the overload indicator.

### FIELD OF THE INVENTION

The invention is related to the field of communication systems and, in particular, to network elements that communicate through Session Initiation Protocol (SIP).

### BACKGROUND

Session Initiation Protocol (SIP) is a signaling protocol defined by the Internet Engineering Task Force (IETF)) for controlling communication sessions over an Internet Protocol (IP) network. For example, SIP may be used to set up, modify, or tear down a voice call, a video call, an IP TV session, an online gaming session, etc. One particular type of IP-based network that uses SIP is an IP Multimedia Subsystem (IMS) network.

The exchange of SIP messages between entities of a network to manage a SIP session is referred to as a SIP transaction. A SIP transaction includes a SIP client (also referred to as a user agent client) that sends SIP requests. The transaction also includes a SIP server (also referred to as a user agent server) that receives SIP requests and returns SIP responses.

### SUMMARY

Embodiments described herein provide for handling overload conditions in a SIP server. A SIP server may experience congestion, hardware or software failures, or some other issue that can overload the server. Presently, when a SIP server experiences an overload condition, the SIP server is still able to respond to a SIP client. Therefore, the client keeps sending requests to the server because it does not know that the server is overloaded. As presently defined, SIP doesn't specify any type of throttling between a SIP client and a SIP server to relieve the overload condition. If a server is experiencing an overload condition and a client continues to send requests as usual, then the overload condition will get worse and may eventually disable the server all together.

The embodiments described herein add message throttling to SIP so that overload conditions are managed between a SIP client and a SIP server. If a SIP server receives a SIP request from a SIP client, then the server determines whether an overload condition exists. If so, the server is able to notify the client of the overload condition through a SIP response. The client then reduces additional SIP requests toward the server that is overloaded. This reduces the burden on the server so that it can recover from the overload condition. When the server does recover, it is able to notify the client of the recovery so that the client can send additional SIP requests toward the server at a normal rate.

One embodiment comprises a SIP client that communicates with a SIP server. The SIP client is configured to send a SIP request to the SIP server, and to receive a SIP response from the SIP server answering the SIP request. The SIP client is configured to parse the SIP response to identify an overload indicator which indicates that an overload condition exists in the SIP server, and to limit additional SIP requests toward the SIP server based on the overload indicator.

In another embodiment, the SIP response includes a new SIP header defined for the overload indicator.

In another embodiment, the overload indicator indicates a severity level of the overload condition in the SIP server.

In another embodiment, the SIP client is configured to limit additional SIP requests toward the SIP server by a percentage based on the severity level of the overload condition.

In another embodiment, the SIP client is configured to send another SIP request to the SIP server, and to receive another SIP response from the SIP server. The SIP client is configured to parse the other SIP response to identify the overload indicator which indicates that the overload condition no longer exists in the SIP server, and to resume transmission of additional SIP requests toward the SIP server at a normal rate based on the overload indicator.

In another embodiment, the SIP client is configured to wait a time period before resuming transmission of the additional SIP requests toward the SIP server at the normal rate.

In another embodiment, the SIP client is configured to gradually increase transmission of the additional SIP requests toward the SIP server until the transmission reaches the normal rate.

In another embodiment, the SIP server is configured to receive the SIP request from the SIP client, and to generate the SIP response as an answer to the SIP request. The SIP server is further configured to detect the overload condition, to insert the overload indicator in the SIP response that the overload condition exists in the SIP server, and to transmit the SIP response to the SIP client.

Another embodiment comprises a method of notifying a SIP client of an overload condition in a SIP server. The method includes sending a SIP request from the SIP client to the SIP server, and receiving a SIP response in the SIP client from the SIP server answering the SIP request. The method further includes parsing the SIP response in the SIP client to identify an overload indicator which indicates that an overload condition exists in the SIP server, and limiting additional SIP requests toward the SIP server based on the overload indicator.

Another embodiment comprises a SIP server that communicates with a SIP client. The SIP server is configured to receive a SIP request from the SIP client, and to generate a SIP response that answers the SIP request. The SIP server is configured to detect an overload condition, to insert an overload indicator in the SIP response that the overload condition exists, and to transmit the SIP response to the SIP client.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIGS. 2-3 are flow charts illustrating a method of exchanging overload handling capabilities via SIP in an exemplary embodiment.

FIG. 4 is a flow chart illustrating a method 400 of notifying a SIP client of overload conditions in an exemplary embodiment.

FIG. 5 is a flow chart illustrating a method 500 of limiting the number of SIP requests that is sent to a SIP server in an exemplary embodiment.

FIG. 6 illustrates communication network in another exemplary embodiment.

FIG. 7 is a message diagram illustrating SIP messaging used to provide overload handling in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

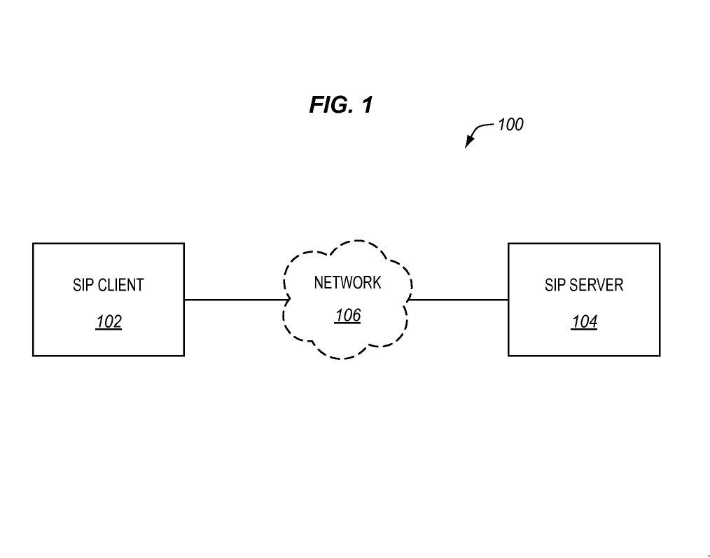

FIG. 1 illustrates a communication network 100 in an exemplary embodiment. Network 100 represents a packet-switched network that uses SIP protocol, such as an IP Multimedia Subsystem (IMS) network. In this embodiment, network 100 includes a SIP client 102 connected to a SIP server 104 by a network 106. Client 102 and server 104 may represent network elements of a packet-switched network. For example, client 102 may represent a Serving-Call Session Control Function (S-CSCF) of an IMS network, while server 104 may represent an application server of an IMS network. Network 100 may include many other SIP user agents that are not shown for the sake of clarity.

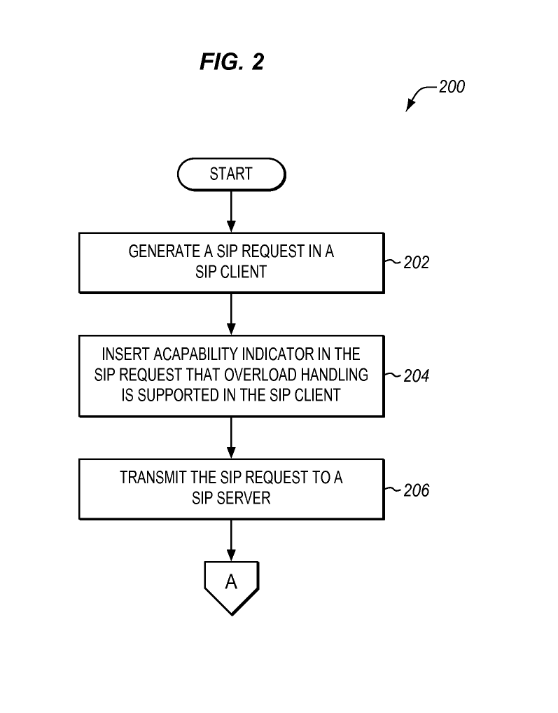

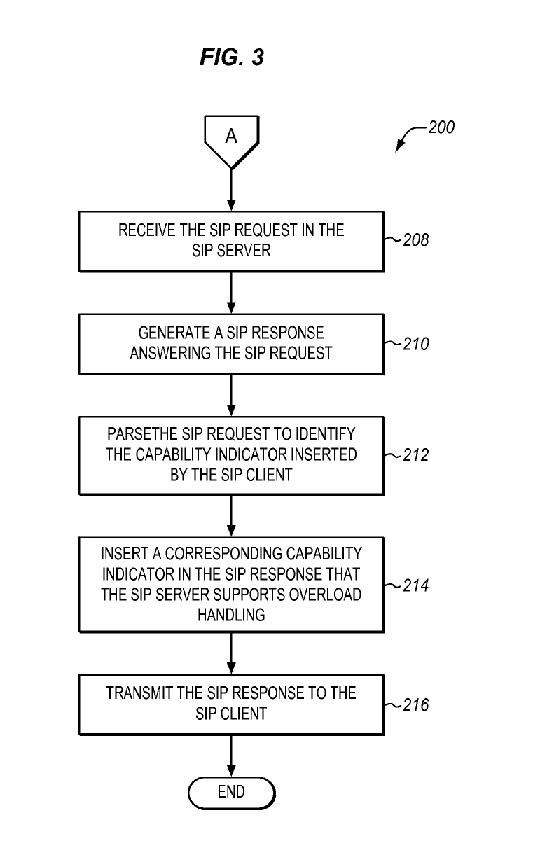

In the embodiments described below, client 102 is able to throttle SIP requests toward server 104 if server 104 becomes overloaded. Before client 102 is able to throttle SIP requests, client 102 can notify server 104 that it supports overload handling and vice-versa, which is further described in FIGS. 2-3.

FIGS. 2-3 are flow charts illustrating a method 200 of exchanging overload handling capabilities via SIP in an exemplary embodiment. The steps of method 200 will be described with reference to network 100 in FIG. 1, but those skilled in the art will appreciate that method 200 may be performed in other networks and systems. The steps of the flow charts described herein are not all inclusive and may include other steps not shown. The steps may also be performed in an alternative order.

In step 202, client 102 generates a SIP request that is intended for server 104, such as a SIP INVITE, a SIP MESSAGE, a SIP OPTIONS, etc. One assumption is that client 102 supports overload handling. In other words, client 102 is able to limit or throttle the number of SIP requests that are sent to a server if the server is overloaded. Therefore, client 102 inserts an indicator (referred to as a capability indicator) in the SIP request that it supports overload handling in step 204. The indicator may comprise a Boolean value, an integer value, a string, etc. Client 102 then transmits the SIP request to server 104 in step 206. The SIP request therefore notifies server 104 that client 102 supports overload handling.

In order to allow for the notification as described above, a new value may be defined in SIP for the capability indicator. The new value may be added to the existing Accept header of SIP messages. The new value may be named “Overload-Notification” value or something similar.

In FIG. 3, server 104 receives the SIP request from client 102 in step 208. As an answer to the SIP request, server 104 generates a SIP response in step 210, such as a SIP 200 OK. Server 104 also parses the SIP request to identify the capability indicator in step 212. If server 104 determines that client 102 supports overload handling (based on the capability indicator), then server 104 determines if it also supports overload handling. If server 104 supports overload handling, then server 104 inserts a corresponding capability indicator in the SIP response (in step 214) that it supports overload handling. As with the SIP request, the capability indicator may be a new value added to the existing Accept header of the SIP response. Server 104 then transmits the SIP response to client 102 in step 216. The SIP response therefore notifies client 102 that server 104 supports overload handling.

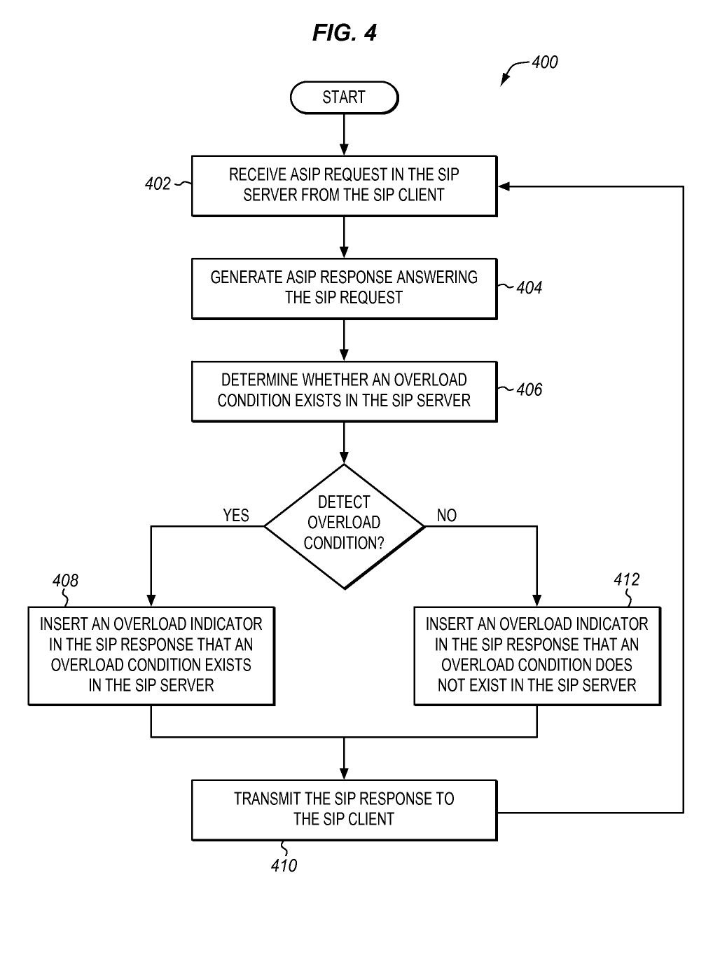

In order to support the SIP sessions in network 100, client 102 will send multiple SIP requests to server 104. For example, client 102 may send SIP INVITEs, SIP MESSAGEs, SIP OPTIONS, etc., to server 104. In the embodiments described herein, SIP is further enhanced so that server 104 can notify client 102 of overload conditions, which is further described in FIG. 4.

FIG. 4 is a flow chart illustrating a method 400 of notifying a SIP client of overload conditions in an exemplary embodiment. The steps of method 400 will be described with reference to network 100 in FIG. 1, but those skilled in the art will appreciate that method 400 may be performed in other networks and systems.

In step 402, server 104 receives a SIP request from client 102. As an answer to the SIP request, server 104 generates a SIP response in step 404, such as a 200 OK. If client 102 supports overload handling (based on the prior notification), then server 104 determines whether an overload condition exists in step 406. An overload condition comprises any condition or processing state where a server operates above its capacity. For example, assume that a server has the capacity to handle 100,000 requests during a time frame. If the server receives 120,000 requests during that time frame, then the server is operating above its capacity and is considered overloaded.

In addition to determining whether an overload condition exists, server 104 may also determine a severity level of the overload condition. The severity level may be a percentage indicating how overloaded the server 104 is. For example, the severity level may be 10%, 50%, 100%, etc.

If an overload condition is detected, then server 104 inserts an overload indicator in the SIP response in step 408. The overload indicator comprises any data which indicates whether an overload condition exists in a SIP user agent. The overload indicator may comprise a Boolean value, an integer value, a string, etc. For example, the overload indicator may be an integer value in the range of 1-10, 1-100, etc. An integer value greater than zero may indicate that an overload condition exists, and may also indicate the severity level of the overload condition. In this instance, the overload indicator indicates that an overload condition does exist in server 104. Server 104 then transmits the SIP response to client 102 in step 410. Thus, server 104 notifies client 102 of the overload condition through the SIP response.

In order to allow for the overload notification as described above, a new SIP header (or header parameter) may be defined for the overload indicator. The new header may have integer value between 0 and 100, where 0 means no overload condition or an overload condition has recovered. A value greater than 0 may indicate an overload condition. The greater the value, the more severe the overload condition. The new header may be named “Overload-Severity” or something similar.

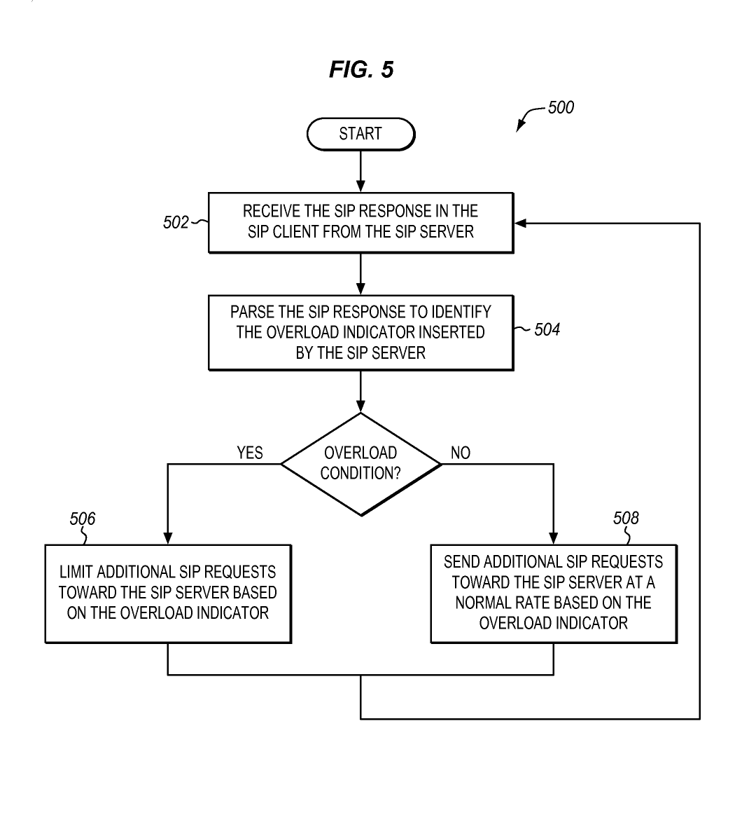

When client 102 receives a SIP response that indicates an overload condition in server 104, client 102 is able to limit the number of future requests that are sent to server 104 while it is overloaded. FIG. 5 is a flow chart illustrating a method 500 of limiting the number of SIP requests that is sent to a SIP server in an exemplary embodiment. The steps of method 500 will be described with reference to network 100 in FIG. 1, but those skilled in the art will appreciate that method 500 may be performed in other networks and systems.

In step 502, client 102 receives the SIP response from server 104. Client 102 parses the SIP response in step 504 to identify the overload indicator inserted by server 104. If the overload indicator indicates that an overload condition exists in server 104, then client 102 limits or throttles additional SIP requests toward server 104 for a time period based on the overload indicator (in step 506). For example, when client 102 determines that server 104 is overloaded, client 102 may start a timer for a throttling window. The timer may be configurable and dynamically changeable. If the overload indicator received from server 104 is an integer value, then client 102 may limit additional SIP requests by a percentage based on the integer value. If the integer value is 50 (on a scale of 1 to 100), then client 102 may limit (or delay) additional SIP requests by 50%. If the integer value is 80 (on a scale of 1 to 100), then client 102 may limit (or delay) additional SIP requests by 80%.

Each time server 104 receives a new SIP request from client 102, server 104 may operate as described in method 400 to determine whether an overload condition exists and/or the severity level of the overload condition. If the overload condition becomes more or less severe, then server 104 notifies client 102 through additional SIP responses. Client 102 continues to limit additional SIP requests toward server 104 while the overload condition exists in server 104. For example, if client 102 receives another SIP response from server 104 indicating that the overload condition still exists, then client 102 may reset the throttling timer and continue to limit new SIP requests toward server 104.

Much as server 104 is able to notify client 102 when an overload condition exists, server 104 is also able to notify client 102 when no overload condition exists or when a prior overload condition has recovered, as is further shown in FIG. 4. When server 104 receives a SIP request from client 102 (see step 402), server 104 generates a SIP response (in step 404) and determines whether an overload condition exists (in step 406). If server 104 does not detect an overload condition or determines that a prior overload condition has recovered, then server 104 inserts an overload indicator in the SIP response in step 412 which indicates that an overload condition does not exist or that an overload condition has recovered. The overload indicator may be an integer value, such as on a scale of 1-10, 1-100, etc. An integer value of zero indicates that no overload condition exists, or that the severity level of an overload condition is zero. Server 104 then transmits the SIP response to client 102 in step 410. Therefore, server 104 is able to notify client 102 that an overload condition no longer exists through the SIP response.

When client 102 receives the SIP response from server 104 (see step 502 of FIG. 5), client 102 parses the SIP response to identify the overload indicator inserted by server 104 (see step 504). In this instance, the overload indicator indicates that no overload condition exists in server 104. Therefore, client 102 terminates throttling and resumes transmission of additional SIP requests toward server 104 at a normal rate in step 508. If client 102 had previously limited SIP requests toward server 104 because it was notified of an overload condition in server 104, then client 102 could return to normal operation and send additional SIP requests toward server 104 in a normal fashion.

It may not be beneficial to bombard server 104 with SIP requests immediately after it recovers from an overload condition. If client 102 (and other clients) sends a large number of SIP requests to server 104 soon after it recovers from an overload condition, then server 104 may become overloaded again. Therefore, client 102 may continue to throttle SIP requests toward server 104 for a time period after server 104 has recovered. Client 102 may wait a time period before resuming transmission of SIP requests toward the SIP server at a normal rate. Alternatively, client 102 may gradually increase transmission of the SIP requests toward the SIP server until reaching its normal rate of transmission. This should avoid a situation where server 104 becomes overloaded again by a large number of SIP requests.

### EXAMPLE

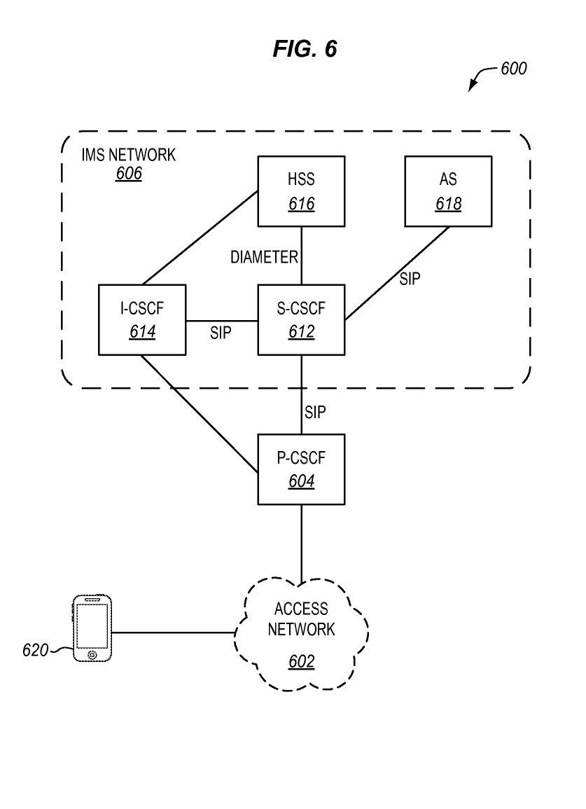

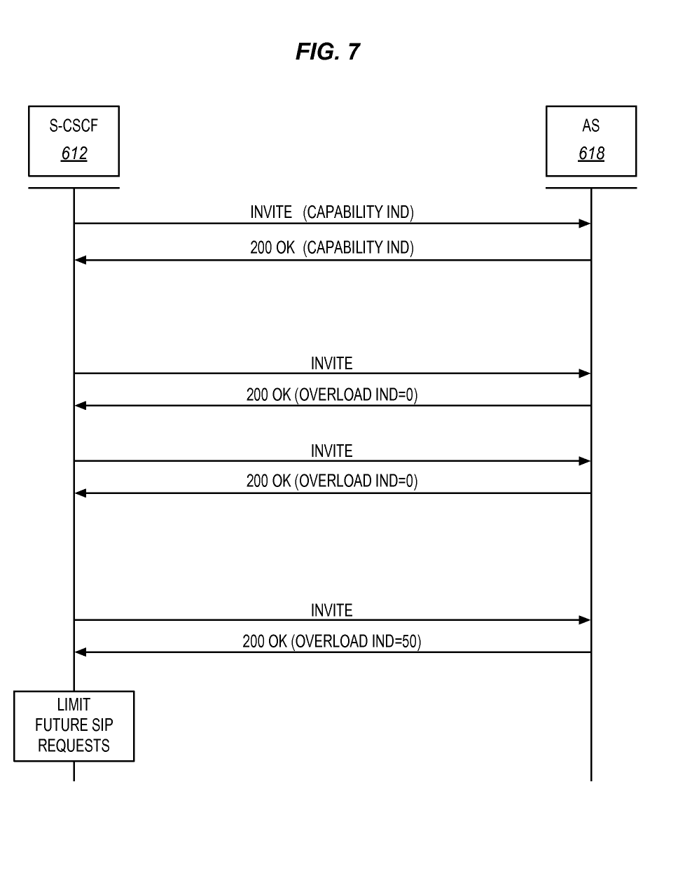

FIGS. 6-7 illustrate an example of operating an IMS network to provide overload handling through SIP protocol. FIG. 6 illustrates communication network 600 in another exemplary embodiment. Communication network 600 includes an access network 602, a Proxy-Call Session Control Function (P-CSCF) 604, and an IMS network 606. IMS network 606 includes a Serving-Call Session Control Function (S-CSCF) 612, an Interrogate-CSCF (I-CSCF) 614, a Home Subscriber Server (HSS) 616, and an application server (AS) 618. A mobile device 620 connects to IMS network 606 through access network 602.

FIG. 7 is a message diagram illustrating SIP messaging used to provide overload handling in an exemplary embodiment. In this example, assume that S-CSCF 612 communicates with AS 618 using SIP. Further assume that S-CSCF 612 receives a SIP INVITE for a session, and determines that AS 618 should be contacted for the session (such as by processing initial filter criteria (iFC)). Before forwarding the SIP INVITE to AS 618, S-CSCF 612 inserts a capability indicator in the SIP INVITE indicating that S-CSCF 612 supports overload handling. S-CSCF 612 inserts the capability indicator in an existing ACCEPT header of the SIP INVITE. S-CSCF 612 then transmits the INVITE to AS 618. The INVITE therefore notifies AS 618 that S-CSCF 612 supports overload handling.

In response to receiving the INVITE, AS 618 generates a response such as a SIP 200 OK. Because the INVITE includes a capability indicator which shows that S-CSCF 612 supports overload handling, AS 618 determines whether AS 618 also supports overload handling. If it does, then AS 618 inserts a corresponding capability indicator in the 200 OK indicating that AS 618 supports overload handling. AS 618 inserts the capability indicator in an existing ACCEPT header of the 200 OK. AS 618 then transmits the 200 OK to S-CSCF 612. The 200 OK therefore notifies S-CSCF 612 that AS 618 supports overload handling.

During the SIP session or other SIP sessions, S-CSCF 612 may send multiple SIP requests toward AS 618, such as new INVITEs, Re-INVITEs, etc. When the SIP requests are received, AS 618 generates the appropriate responses, such as 200 OKs. Because both AS 618 and S-CSCF 612 support overload handling based on the prior notifications, then AS 618 determines whether an overload condition exists and a severity level of the overload condition.

If an overload condition is not detected (as with the first two INVITEs), then AS 618 inserts an overload indicator (OVERLOAD IND) in the 200 OK that no overload condition exists. More particularly, AS 618 inserts the overload indicator in a new SIP header defined for SIP responses. In this example, the overload indicator comprises an integer value in the range of 0-100. An integer value of zero indicates that an overload condition does not exist or no longer exists. AS 618 then sends the 200 OK to S-CSCF 612.

If an overload condition is detected (as with the third INVITE), then AS 618 inserts an overload indicator in the 200 OK that an overload condition does exist. An integer value greater than zero (e.g., 50 in FIG. 7) indicates that an overload condition exists, and also indicates the severity level of the overload condition. Because an overload condition was detected, the overload indicator is a value between 1-100 depending on the severity of the overload condition. AS 618 then transmits the 200 OK to S-CSCF 612.

When S-CSCF 612 receives the 200 OK that indicates an overload condition in AS 618, S-CSCF 612 is able to limit the number of future SIP requests that are sent to AS 618 while it is overloaded. For example, S-CSCF 612 may set a throttling timer during which time S-CSCF 612 will throttle SIP requests toward AS 618. S-CSCF 612 may throttle additional SIP requests toward AS 618 by 50% based on the integer value of the overload indicator (which is 50). By limiting future SIP requests toward AS 618, the overload condition may be resolved more quickly or easily.

The above example illustrates that overload handling can be implemented effectively through SIP. The addition of new SIP headers allows a SIP server to notify a SIP client of overload conditions so that the client can reduce the number of SIP requests that are sent to the server while the server attempts to recover from an overload condition.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a Session Initiation Protocol (SIP) client configured to send a SIP request to a SIP server, and to receive a SIP response from the SIP server;
wherein the SIP client is configured to parse the SIP response to identify an overload indicator which indicates that an overload condition exists in the SIP server, and to limit additional SIP requests toward the SIP server based on the overload indicator.

2. The system of claim 1 wherein:
the SIP response includes a new SIP header defined for the overload indicator.

3. The system of claim 2 wherein:
the overload indicator indicates a severity level of the overload condition.

4. The system of claim 3 wherein:
the SIP client is configured to limit additional SIP requests toward the SIP server by a percentage based on the severity level of the overload condition.

5. The system of claim 1 wherein:
the SIP client is configured to send another SIP request to the SIP server, and to receive another SIP response from the SIP server;
the SIP client is configured to parse the other SIP response to identify the overload indicator which indicates that the overload condition no longer exists in the SIP server, and to resume transmission of additional SIP requests toward the SIP server at a normal rate based on the overload indicator.

6. The system of claim 5 wherein:
the SIP client is configured to wait a time period before resuming transmission of the additional SIP requests toward the SIP server at the normal rate.

7. The system of claim 5 wherein:
the SIP client is configured to gradually increase transmission of the additional SIP requests toward the SIP server until the transmission reaches the normal rate.

8. The system of claim 1 wherein:
the SIP server is configured to receive the SIP request from the SIP client, and to generate the SIP response as an answer to the SIP request;
the SIP server is configured to detect the overload condition, to insert the overload indicator in the SIP response that the overload condition exists in the SIP server, and to transmit the SIP response to the SIP client.

9. A method comprising
sending a Session Initiation Protocol (SIP) request from a SIP client to a SIP server;
receiving a SIP response in the SIP client from the SIP server;
parsing the SIP response in the SIP client to identify an overload indicator which indicates that an overload condition exists in the SIP server; and
limiting additional SIP requests toward the SIP server based on the overload indicator.

10. The method of claim 9 wherein:
the SIP response includes a new SIP header defined for the overload indicator.

11. The method of claim 10 wherein:
the overload indicator indicates a severity level of the overload condition.

12. The method of claim 11 wherein limiting additional SIP requests toward the SIP server based on the overload indicator comprises:
limiting the additional SIP requests toward the SIP server by a percentage based on the severity level of the overload condition.

13. The method of claim 9 further comprising:
sending another SIP request from the SIP client to the SIP server;
receiving another SIP response from the SIP server;
parsing the other SIP response to identify the overload indicator which indicates that the overload condition no longer exists in the SIP server; and
resuming transmission of additional SIP requests toward the SIP server at a normal rate based on the overload indicator.

14. The method of claim 13 wherein resuming transmission of additional SIP requests toward the SIP server comprises:
waiting a time period before resuming transmission of the additional SIP requests toward the SIP server at the normal rate.

15. The method of claim 13 wherein resuming transmission of additional SIP requests toward the SIP server comprising:
gradually increasing transmission of the additional SIP requests toward the SIP server until the transmission reaches the normal rate.

16. The method of claim 9 further comprising:
receiving the SIP request in the SIP server from the SIP client;
generating the SIP response in the SIP server as an answer to the SIP request;
detecting the overload condition in the SIP server;
inserting the overload indicator in the SIP response that the overload condition exists in the SIP server; and
transmitting the SIP response from the SIP server to the SIP client.

17. A system comprising:
a Session Initiation Protocol (SIP) server configured to receive a SIP request from a SIP client, and to generate a SIP response that answers the SIP request;
the SIP server is configured to detect an overload condition, to insert an overload indicator in the SIP response that the overload condition exists, and to transmit the SIP response to the SIP client.

18. The system of claim 17 wherein:
the SIP response includes a new SIP header defined for the overload indicator.

19. The system of claim 18 wherein:
the SIP server is configured to determine a severity level for the overload condition, and to set the overload indicator to indicate the severity level.

20. The system of claim 17 wherein:
the SIP server is configured to receive another SIP request from the SIP client, and to generate another SIP response;
the SIP server is configured to determine that the overload condition no longer exists, to insert the overload indicator in the other SIP response that the overload condition no longer exists in the SIP server, and to transmit the other SIP response to the SIP client.
